(19) United States
(12) Patent Application Publication
(10) Pub. No.: US 2017/0075492 A1
(43) Pub. Date: Mar. 16, 2017

(54) DISPLAY DEVICE AND METHOD OF MANUFACTURING THE SAME

(71) Applicant: SAMSUNG DISPLAY CO., LTD., Yongin-si (KR)

(72) Inventors: Changmok Kim, Yongin-si (KR); Jinho Kwak, Yongin-si (KR); Youngseo Choi, Yongin-si (KR)

(21) Appl. No.: 15/170,808

(22) Filed: Jun. 1, 2016

(30) Foreign Application Priority Data
Sep. 15, 2015 (KR) 10-2015-0130595

(51) Int. Cl. G06F 3/041

(52) U.S. Cl. CPC G06F 3/0418; G06F 2203/04102; G06F 2203/04103

(57) ABSTRACT

A display apparatus is provided. The display apparatus includes: a substrate; a display unit on the substrate; an encapsulating unit on the display unit, the encapsulating unit encapsulating the display unit; a first layer on the encapsulating unit; a porous layer on the first layer; a touch film on the first layer; and a polarizing plate on the touch film.

### CROSS-REFERENCE TO RELATED APPLICATION

This application claims priority to and the benefit of Korean Patent Application No. 10-2015-0130595, filed on Sep. 15, 2015, in the Korean Intellectual Property Office, the entire content of which is incorporated herein by reference.

### BACKGROUND

1. Field

Aspects of one or more exemplary embodiments relate to a display apparatus and a method of manufacturing the same.

2. Description of the Related Art

With the development of information technologies, the market for display apparatuses that are capable of connecting users with information has increased. Accordingly, display apparatuses, such as liquid crystal displays (LCD), organic light-emitting diode displays, electro-phoretic displays (EPD), plasma display panels (PDP), etc., are increasingly used.

Recently, demands for display panels are not limited to flat display panels, but include flexible display panels, which may be folded or unfolded in various directions. To apply a touch function to flexible display panels, a touch film, which is not fractured when the display panel is bent, is used.

However, in such a display apparatus, a parasitic capacitance may be generated between an electrode in the display apparatus and the touch film, and thus, image quality may deteriorate.

### SUMMARY

To reduce or eliminate parasitic capacitance between the electrode and the touch film, a constant distance between the electrode and the touch film is desired, and an organic layer and an inorganic layer may be additionally provided between the electrode and the touch film to maintain a constant distance.

However, outgassing by any additionally provided organic layer may cause color fading of a polarizing plate on the touch film.

One or more exemplary embodiments of the present invention are directed toward a display apparatus and a method of manufacturing the same that may prevent or substantially prevent color fading of a polarizing plate on a touch film.

Additional aspects will be set forth in part in the description which follows and, in part, will be apparent from the description, or may be learned by practice of the presented embodiments.

According to one or more exemplary embodiments, a display apparatus includes: a substrate; a display unit on the substrate; an encapsulating unit on the display unit, the encapsulating unit encapsulating the display unit; a first layer on the encapsulating unit; a porous layer on the first layer; a touch film on the first layer; and a polarizing plate on the touch film.

The first layer and the porous layer may include an organic layer and an inorganic layer, respectively.

The first layer may include at least one bubble.

The porous layer may include at least one crack.

The porous layer may include at least one hole, and the at least one hole may penetrate through the porous layer.

The porous layer may include at least two holes, and the at least two holes may be distributed throughout the porous layer.

The porous layer may include lithium fluoride.

According to one or more exemplary embodiments, a display apparatus includes: a substrate; a display unit on the substrate; an encapsulating unit on the display unit, the encapsulating unit encapsulating the display unit; a first layer on the encapsulating unit; a porous layer on the first layer; a second layer on the porous layer; a touch film on the second layer; and a polarizing plate on the touch film.

The first layer and the second layer may include an organic layer and an inorganic layer, respectively.

The first layer may include at least one bubble.

The second layer may include at least one crack.

The porous layer may include at least one hole, and the at least one hole may penetrate through the porous layer.

The porous layer may include lithium fluoride.

According to one or more exemplary embodiments, a method of manufacturing a display apparatus includes: providing a substrate; forming a display unit on the substrate; forming an encapsulating unit on the display unit, the encapsulating unit encapsulating the display unit; depositing an organic layer on the encapsulating unit; depositing a porous layer on a first layer; forming a touch film on the porous layer; and forming a polarizing plate on the touch film.

The depositing of the porous layer may be performed by a thermal evaporation process.

The porous layer deposited by the thermal evaporation process may include a porous crystal layer including lithium fluoride.

The method may further include depositing an inorganic layer on the porous layer, after depositing the porous layer.

### BRIEF DESCRIPTION OF THE DRAWINGS

These and/or other aspects will become apparent and more readily appreciated from the following description of the exemplary embodiments, taken in conjunction with the accompanying drawings in which:

FIG. 1 is a plan view of a display apparatus according to an exemplary embodiment of the present invention;

FIG. 2A is a cross-sectional view of the display apparatus of FIG. 1;

FIG. 2B is a cross-sectional view of a display apparatus according to another exemplary embodiment;

FIG. 3 is an enlarged cross-sectional view of the display apparatus of FIG. 2A, which focuses on a display unit;

FIG. 4 is a plan view of a touch film included in a display apparatus according to an exemplary embodiment of the present invention;

FIG. 5 is a plan view illustrating in detail some of sensing patterns included in the touch film of FIG. 4; and

FIG. 6 is a cross-sectional view of a display apparatus, which focuses on a first layer, a porous layer, and a second layer, according to an exemplary embodiment.

### DETAILED DESCRIPTION

Features of the invention and methods of accomplishing the same may be understood more readily by reference to the following detailed description of embodiments and the accompanying drawings. The invention may, however, be embodied in many different forms and should not be construed as being limited to the embodiments set forth herein. Rather, these embodiments are provided as examples so that this disclosure will be thorough and complete, and will fully convey the aspects and features of the present invention to those skilled in the art. Accordingly, processes, elements, and techniques that are not necessary to those having ordinary skill in the art for a complete understanding of the aspects and features of the present invention may not be described. Unless otherwise noted, like reference numerals denote like elements throughout the attached drawings and the written description, and thus, descriptions thereof may not be repeated. In the drawings, the relative sizes of elements, layers, and regions may be exaggerated for clarity.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present invention.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

The terminology used herein is for the purpose of describing particular embodiments only and is not intended to be limiting of the present invention. As used herein, the singular forms “a,” “an,” and “the” are intended to include the plural forms as well, unless the context clearly indicates otherwise. It will be further understood that the terms “comprises,” “comprising,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Expressions such as “at least one of,” when preceding a list of elements, modify the entire list of elements and do not modify the individual elements of the list.

As used herein, the term “substantially,” “about,” and similar terms are used as terms of approximation and not as terms of degree, and are intended to account for the inherent variations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

The electronic or electric devices and/or any other relevant devices or components according to embodiments of the present invention described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate. Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the exemplary embodiments of the present invention.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

When a certain embodiment may be implemented differently, a specific process order may be performed differently from the described order. For example, two consecutively described processes may be performed at substantially the same time or performed in an order opposite to the described order.

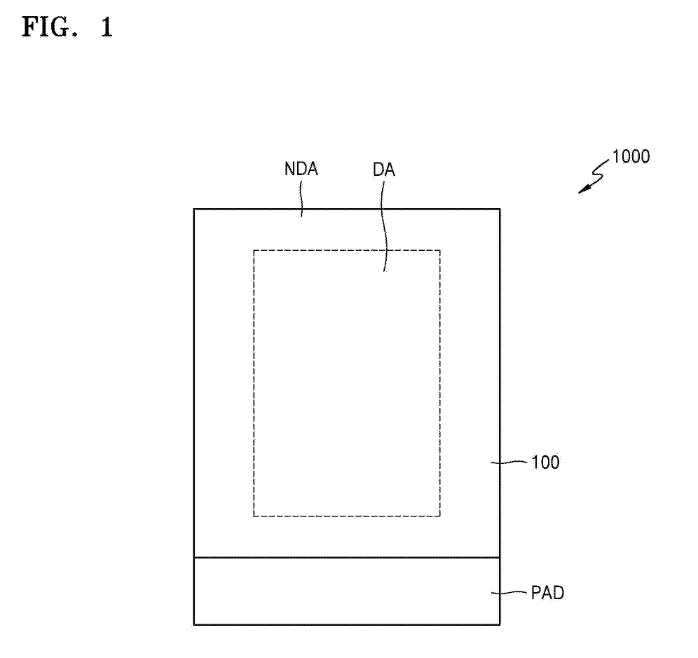

FIG. 1 is a plan view of a display apparatus 1000 according to an exemplary embodiment of the present invention. According to one embodiment, a substrate 100 may include various materials having flexibility, and may include a plastic material having excellent heat resistance and durability.

The substrate 100 may include a display area DA for producing an image that a user may recognize, and a non-display area NDA, which is around the display area DA.

In the display area DA, various devices for generating light may be provided, such as an organic light-emitting device (OLED) or a liquid crystal display device. In the non-display area NDA, a voltage line for providing power to the display area DA may be provided.

Also, in the non-display area NDA, a pad unit PAD for transferring an electrical signal from a power supply or a signal generator to the display area DA may be provided.

The pad unit PAD may include a driver IC, a pad connecting the driver IC and a pixel circuit to each other, and a fanout wire.

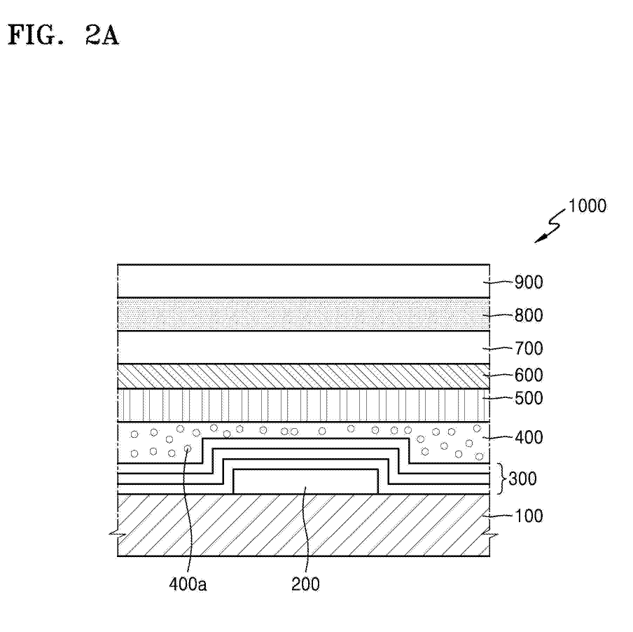

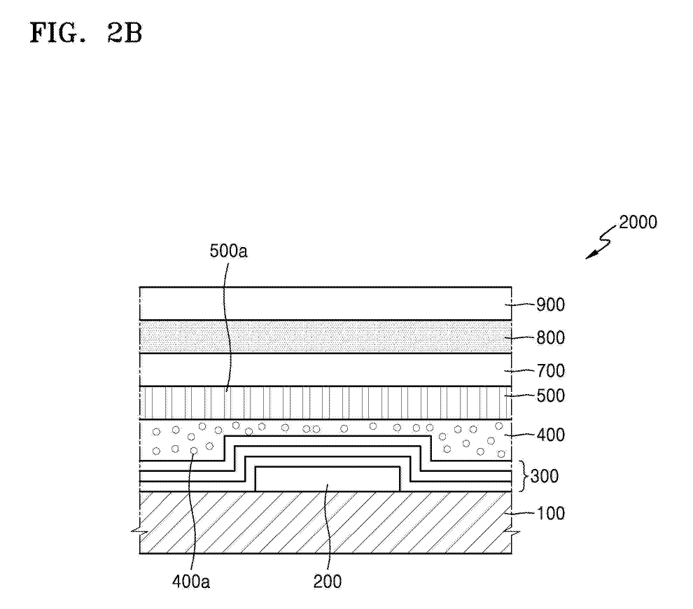

FIG. 2A is a cross-sectional view of the display apparatus 1000 of FIG. 1.

The display apparatus 1000 according to the present exemplary embodiment may include the substrate 100, a display unit 200 provided on the substrate 100, and an encapsulating unit 300 encapsulating the display unit 200.

As described above, the substrate 100 may include various materials. According to another embodiment, the substrate 100 may include a transparent glass material, mainly including SiO₂. However, the substrate 100 is not limited thereto. The substrate 100 may include a transparent plastic material. The plastic material may be an organic material selected from the group consisting of polyethersulphone (PES), polyacrylate (PAR), polyetherimide (PEI), polyethylene naphthalate (PEN), polyethylene terephthalate (PET), polyphenylene sulfide (PPS), polyallylate, polyimide, polycarbonate (PC), cellulose tri acetate (TAC), and cellulose acetate propionate (CAP), which are insulating organic materials, and combinations thereof.

In the display apparatus 1000 according to the present exemplary embodiment, the substrate 100 may be formed to be two-dimensionally flexible such that if stretches in two dimensions.

According to another embodiment, the substrate 100 may include a material having a Poisson's ratio that is equal to or greater than 0.4. The Poisson's ratio denotes a rate at which a length in one direction is compressed (or decreased) when a length in the other direction expands (or extends).

The substrate 100 may include the material having a Poisson's ratio that is equal to or greater than 0.4 in order to be easily stretchable (e.g., expandable). Thus, the substrate 100 may have increased flexibility so that the display apparatus 1000 may be easily bent or folded.

The display unit 200 may be formed on the substrate 100.

The display unit 200 generates visible rays which a user may recognize. The display unit 200 may include various devices. For example, the display unit 200 may include an OLED display device or a liquid crystal display device.

In the display apparatus 1000 according to the present exemplary embodiment, the display unit 200 may include an OLED display device. This aspect will be described in detail later.

The display apparatus 1000 may further include the encapsulating unit 300 to completely encapsulate the display unit 200 so that the display unit 200 is protected from external water or oxygen.

According to another embodiment, the encapsulating unit 300 may be formed on the display unit 200, and both ends of the encapsulating unit 300 may adhere to the substrate 100.

According to another embodiment, the encapsulating unit 300 may be a stack including a plurality of thin film layers, wherein an inorganic layer and an organic layer are alternately stacked.

The inorganic layer may solidly block oxygen or water penetration, and the organic layer may absorb stress from the inorganic layer to provide flexibility to the encapsulating unit 300. Thus, the display apparatus 1000 may have improved flexibility due to the organic layer included in the encapsulating unit 300. The inorganic layer may be a single layer or multiple stacked layers including a metal oxide or a metal nitride. According to another embodiment, inorganic layers may include SiN_{X}, Al₂O₃, SiO₂, or TiO₂.

The organic layer may include a polymer. For example, the organic layer may be a single layer or multiple stacked layers including polyethylene terephthalate, polyimide, polycarbonate, epoxy, polyethylene, or polyacrylate. For example, the organic layers may include polyacrylate. In detail, the organic layers may include a polymerized monomer composition, wherein the monomer composition includes a diacrylate-based monomer and a triacrylate-based monomer. The monomer composition may further include a monoacrylate-based monomer. Also, the monomer composition may further include a photoinitiator, such as TPO. However, the monomer composition is not limited thereto.

In the display apparatus 1000 according to the present exemplary embodiment, a first layer 400, a porous layer 500, a second layer 600, and a touch film 700 may be sequentially stacked on the encapsulating unit 300 in this stated order. The first layer 400 may be an organic layer.

The display unit 200 may include a light-emitting device, such as an OLED, and the light-emitting device may include an electrode, as described below. Here, a parasitic capacitance may be generated between the electrode included in the display unit 200 and the touch film 700 on the display unit 200. If the parasitic capacitance is generated between the electrode included in the display unit 200 and the touch film 700 on the display unit 200, sensing sensitivity may deteriorate.

Parasitic capacitance generated between two layers is a value that is inversely proportional to a distance d between the two layers. In order to reduce the parasitic capacitance between the display unit 200 and the touch film 700, a constant distance between the display unit 200 and the touch film 700 is used.

Thus, according to another embodiment, in order to maintain a constant distance between the display unit 200 and the touch film 700, the first layer 400 may be provided. Since a layer having a thickness (e.g., a predetermined thickness) has to be formed, the first layer 400 may be an organic layer.

According to another embodiment, the first layer 400 may have a thickness of 10 μm.

The first layer 400 may include a single layer or multiple layers including an organic material. The first layer 400 may be formed by various deposition methods. In some embodiment, the first layer 400 may include at least one of polyacrylate resin, epoxy resin, phenolic resin, polyamide resin, polyimide resin, unsaturated polyester resins, polyphenylene ether resin, poly phenylenesulfide resin, and benzocyclobutene (BCB).

When the first layer 400 includes the organic material, the first layer 400 may be easily deposited to have a thickness (e.g., a predetermined thickness), and thus, the display unit 200 and the touch film 700 may be easily maintained at a constant distance.

According to another embodiment, the second layer 600 may be formed on the first layer 400.

The second layer 600 may be an inorganic layer.

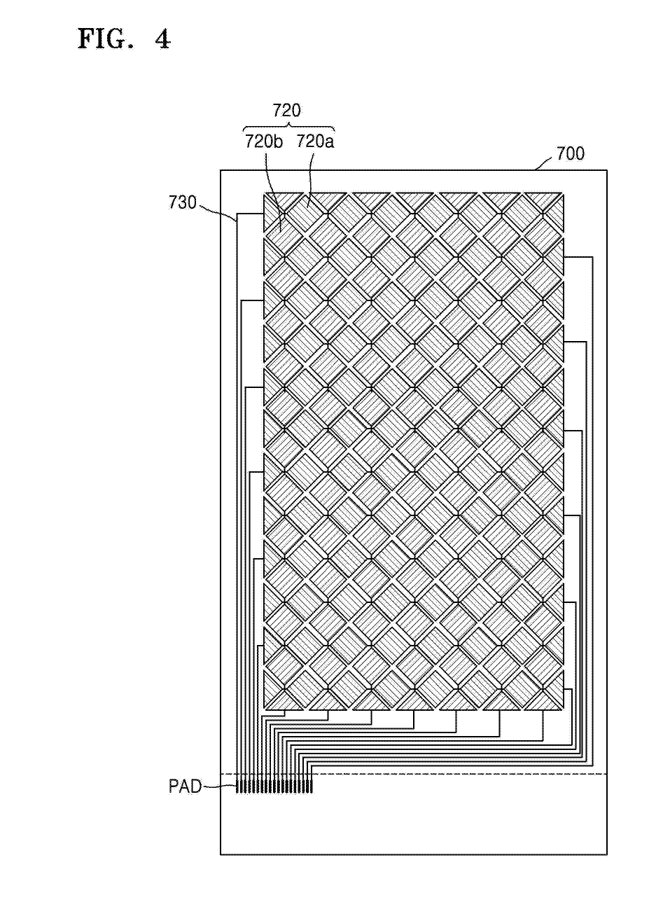

When the touch film 700 is directly bonded on the first layer 400 including an organic material, adhesion may be weak. The touch film 700 may include an inorganic material, and the touch film 700 may be an inorganic layer on which sensing patterns 720 (refer to FIG. 4) may be formed, as described below.

In this case, adhesion between the touch film 700, which is a patterned inorganic layer, and the first layer 400, which is an organic layer, may deteriorate and cause a reduction in reliability.

Thus, in order to improve adhesion, the second layer 600, which is a non-patterned planarization layer, may be formed between the touch film 700 and the first layer 400.

According to another embodiment, the second layer 600 may include a planarized inorganic layer, and the second layer 600 may improve the adhesion between the first layer 400 and the touch film 700.

According to another embodiment, a thickness of the second layer 600 may be less than a thickness of the first layer 400.

The second layer 600 may include a single layer or multiple layers including an inorganic material.

According to another embodiment, the second layer 600 may be deposited by a chemical vapor deposition (CVD) process. In some embodiments, the second layer 600 may be a metal oxide or a metal nitride. In detail, the inorganic material may include, for example, SiO₂, SiNx, SiON, Al₂O₃, TiO₂, Ta₂O₅, HfO₂, and/or ZrO₂.

According to another embodiment, the display apparatus 1000 may further include the porous layer 500 between the first layer 400 and the second layer 600.

According to another embodiment, the porous layer 500 may be formed to have a plurality of openings (e.g., a plurality of holes).

The structure and function of the porous layer 500 will be described in detail later.

The touch film 700 may be formed on the second layer 600.

The touch film 700 may be arranged on the display unit 200. When an object approaches the touch film 700 or touches the touch film 700, the touch film 700 may sense the object. Here, contact denotes not only the case in which an external object, such as a user's finger, directly contacts the touch film 700, but also the case in which the object approaches the touch film 700 or approaches the touch film 700 and hovers around the touch film 700.

The structure of the touch film 700 will be described in detail later with the accompanying drawings.

A polarizing plate 800 and a window 900 may be formed on the touch film 700.

The polarizing plate 800 may increase contrast by reducing the reflection of external light.

The polarizing plate 800 may change the optical axis of light that is emitted to the outside by the display unit 200. Generally, the polarizing plate 800 may have a structure in which a transparent protective film is stacked on both surfaces or a single surface of a polarizer including a polyvinyl alcohol-based resin.

According to another embodiment, the polarizing plate 800 may have a structure including a triacetate cellulose (TAC) film bonded to a polarizer as a protective film, a polyvinyl alcohol (PVA)-based chain of molecules arranged in a constant direction, and an iodine-based compound or a dichromatic polarizing material. Here, the polarizer and the protective film may be bonded to each other by a water-based adhesive, which generally includes a polyvinyl alcohol-based aqueous solution.

However, the structure of the polarizing plate 800 is not limited thereto, and polarizing plates of various structures may be used.

A resin layer may be formed on the polarizing plate 800. The resin layer may bond the window 900 and the polarizing plate 800 in order to space the window 900 and the polarizing plate 800 apart from each other.

According to another embodiment, the resin layer may be formed by curing a liquid resin. The resin layer may be formed by using a transparent liquid resin.

In the display apparatus 1000 according to the present exemplary embodiment, the window 900 may be arranged on the polarizing plate 800 to be bonded to the polarizing plate 800 by the resin layer.

The window 900 may protect the polarizing plate 800, the touch film 700, and the display unit 200 located below the window 900, from external forces and pollutants.

FIG. 2B is a cross-sectional view of a display apparatus 2000 according to another exemplary embodiment. In FIG. 2B, like reference numerals refer to like elements in FIG. 2A, and their descriptions may be omitted for brevity of explanation.

The display apparatus 1000 of FIG. 2A has a structure in which the porous layer 500 and the second layer 600 are sequentially stacked on the first layer 400 and on the encapsulating layer 300 in this stated order. However, this is only an exemplary embodiment, and the structure of display apparatuses according to the present inventive concept is not limited thereto.

In the display apparatus 2000 of FIG. 2B, a second layer 600 may not be stacked on the first layer 400, and only the porous layer 500 and the touch film 700 may be formed on the first layer 400.

For example, when there is no problem of adhesion deterioration between the first layer 400 and the touch film 700, the second layer 600 for increasing adhesion may not be needed, and the porous layer 500 and the touch film 700 may be sequentially formed on the first layer 400.

According to another embodiment, the polarizing plate 800 and the window 900 may be sequentially stacked on the touch film 700 in this stated order.

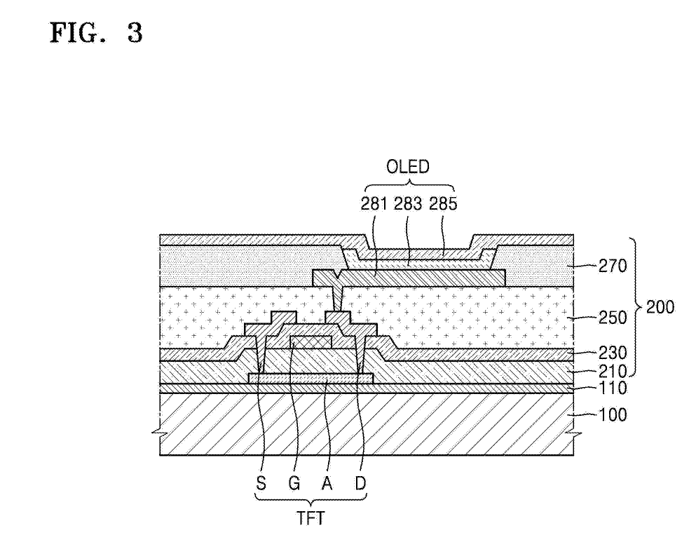

FIG. 3 is an enlarged cross-sectional view of the display apparatus 2000 of FIG. 2A, which focuses on the display unit 200. As described above, the display unit 200 may include various light-emitting devices, such as an OLED, and/or a liquid crystal display device. Hereinafter, an exemplary embodiment in which the display unit 200 includes an OLED will be described for convenience of explanation.

A buffer layer 110 may be formed on the substrate 100. The buffer layer 110 may prevent or substantially prevent diffusion of impurities (such as impure ions) and may prevent or substantially prevent penetration of water and external materials through the substrate 100. The buffer layer 110 may also function as a barrier layer and/or a blocking layer to planarize the surface of the substrate 100.

According to another embodiment, the buffer layer 110 may include an inorganic layer, and may be formed throughout the substrate 100.

A thin film transistor (TFT) may be formed on the buffer layer 110. An active layer A of the TFT may include polysilicon, and may include a channel area which is not doped with impurities, and a source area and a drain area at both sides of the channel area that are doped with impurities. Here, the impurities may vary depending on the types of TFT, and may include n-type impurities or p-type impurities.

After the active layer A is formed, a gate insulating layer 210 may be formed on the active layer A.

The gate insulating layer 210 may include a single layer or multiple layers including an inorganic material, such as a silicon oxide or a silicon nitride. The gate insulating layer 210 may insulate the active layer A from a gate electrode G on the gate insulating layer 210.

According to another embodiment, the gate insulting layer 210 may include an inorganic layer, and may be formed over the entire substrate 100.

After the gate insulating layer 210 is formed, the gate electrode G may be formed on the gate insulating layer 210. The gate electrode G may be formed by a photolithography process and/or an etching process.

The gate electrode G may include at least one metal selected from Mo, Al, Pt, Pd, Ag, Mg, Au, Ni, Nd, Ir, Cr, Li, Ca, Ti, W, and Cu.

An interlayer insulating layer 230 may be formed over the entire substrate 100 and may cover the gate electrode G, after the gate electrode G is formed.

The interlayer insulating layer 230 may include an inorganic material. For example, the interlayer insulating layer 230 may be a metal oxide or a metal nitride. In detail, the inorganic material may include, for example, SiO₂, SiN_{X}, SiO_{N}, Al₂O₃, TiO₂, Ta₂O₅, HfO₂, and/or ZrO₂.

The interlayer insulating layer 230 may include a single layer or multiple stacked layers including an inorganic material, such as SiOₓ and/or SiN_{X}. In some embodiments, the interlayer insulating layer 230 may be formed as a double structure of SiOₓ/SiN_{y} or SiNₓ/SiO_{y}.

A source electrode S and a drain electrode D of the TFT may be arranged on the interlayer insulating layer 230.

The source electrode S and the drain electrode D may include at least one metal selected from Al, Pt, Pd, Ag, Mg, Au, Ni, Nd, Ir, Cr, Li, Ca, Mo, Ti, W, and Cu.

A via layer 250 may be formed on the interlayer insulating layer 230 and may cover the source electrode S and the drain electrode D. A first electrode 281 may be formed on the via layer 250. According to the exemplary embodiment illustrated in FIG. 3, the first electrode 281 is connected to the drain electrode D via a via opening (e.g., a via hole).

The via layer 250 may include an insulating material. For example, the via layer 250 may include a single layer or multiple layers including an inorganic material, an organic material, or an organic/inorganic compound. The via layer 250 may be formed by using various deposition methods. In some embodiments, the via layer 250 may include at least one of polyacrylate resin, epoxy resin, phenolic resin, polyamide resin, polyimide resin, unsaturated polyester resins, poly phenylene ether resins, poly phenylenesulfide resin, and BCB.

The OLED may be formed on the via layer 250.

The OLED includes the first electrode 281, an intermediate layer 283 including an organic emission layer, and a second electrode 285. Also, the display apparatus 2000 may further include a pixel-defining layer 270.

Light may be generated when holes and electrons injected in the first electrode 281 and the second electrode 285 of the OLED combine in the organic emission layer of the intermediate layer 283.

The first electrode 281 and/or the second electrode 285 may include a transparent electrode or a reflection electrode. When the first electrode 281 and/or the second electrode 285 includes a transparent electrode, the first electrode 281 and/or the second electrode 285 may include ITO, IZO, ZnO, or In₂O₃. When the first electrode 281 and/or the second electrode 285 includes a reflection electrode, the first electrode 281 and/or the second electrode 285 may include a reflective layer including Ag, Mg, Al, Pt, Pd, Au, Ni, Nd, Ir, Cr, or a compound thereof, and a transparent layer including ITO, IZO, ZnO, or In₂O₃. In some embodiments, the pixel electrode 281 (or first electrode 281) or the opposite electrode 285 (or second electrode 285) may have a ITO/Ag/ITO structure.

As described above, the OLED may include the second electrode 285, and the second electrode 285 may generate a parasitic capacitance in relation with the touch film 700 arranged on the second electrode 285. When the parasitic capacitance is generated, the sensing sensitivity of the touch film 700 may deteriorate.

Accordingly, in order to reduce the parasitic capacitance generated between the second electrode 285 and the touch film 700, the first layer 400 (refer to FIG. 2A) may be formed to maintain a distance between the second electrode 285 and the touch film 700.

The intermediate layer 283 may be formed between the first electrode 281 and the second electrode 285, and may include the organic emission layer.

According to another embodiment, the intermediate layer 283 may include the organic emission layer, and may further include at least one of a hole injection layer (HIL), a hole transport layer (HTL), an electron transport layer (ETL), and an electron injection layer (EIL). However, the present exemplary embodiment is not limited thereto, and the intermediate layer 283 may include the organic emission layer, and may further include other various function layers.

A spacer (not shown) may further be formed on the pixel-defining layer 270. The spacer may be formed to protrude in an upward direction from the pixel-defining layer 270, and may be provided to help prevent or substantially prevent deterioration of display characteristics due to external shocks.

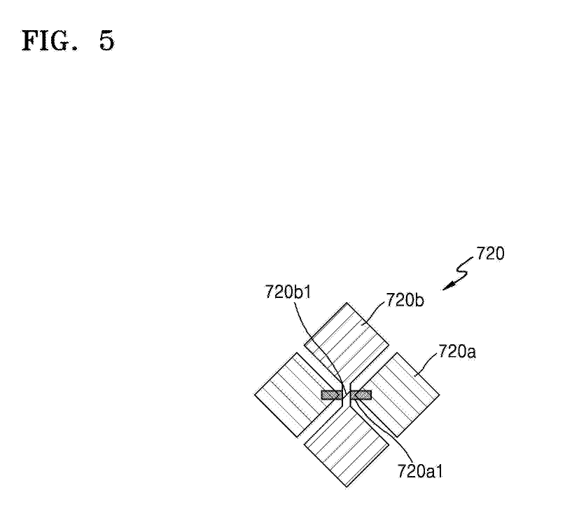

FIG. 4 is a plan view of the touch film 700 included in a display apparatus according to an exemplary embodiment. FIG. 5 is a plan view illustrating in detail some of the sensing patterns 720 included in the touch film 700.

The touch film 700 may include a base film and the sensing patterns 720 formed on the base film.

As illustrated in FIG. 4, the sensing patterns 720 may include a plurality of first sensing cells 720a and a plurality of second sensing cells 720b.

According to another embodiment, the first sensing cells 720a and the second sensing cells 720b may include a transparent conductive material, such as ITO.

The plurality of sensing patterns 720 may be electrically connected to sensing lines 730, and may be connected to the pad unit PAD and external driving circuits via the sensing lines 730.

The sensing lines 730 are arranged in the non-display area NDA (refer to FIG. 1), which is outside the display area DA (refer to FIG. 1) on which an image is displayed. The sensing lines 730 may include a wide range of materials. For example, in addition to transparent conductive materials, the sensing patterns 720 may include low-resistive metal materials, such as Mo, Ag, Ti, Cu, Ti, and Mo/Al/Mo.

The touch film 700 according to the present exemplary embodiment is a capacitive touch panel. When an object such as a human finger or a stylus pen contacts the touch film 700, a change in capacitance according to a contact location may be transferred from the sensing patterns 720 to the driving circuits via the sensing lines 730 and the pad unit PAD.

Then, the change in capacitance is converted into an electrical signal by X and Y input processing circuits so that the contact location is determined.

Referring to FIG. 5, the sensing patterns 720 may include the plurality of first sensing cells 720a formed to be connected with one another in rows, and a plurality of first connection lines 720a1 connecting the first sensing cells 720a in the row direction.

Also, the sensing patterns 720 may include the plurality of second sensing cells 720b formed to be connected with one another in columns, and a plurality of second connection lines 720b1 connecting the second sensing cells 720a in the column direction.

For convenience, FIG. 5 illustrates only some of the sensing patterns 720. However, the touch film 700 may have a structure in which the sensing patterns illustrated in FIG. 5 are repeatedly arranged.

The first sensing cells 720a and the second sensing cells 720b may be alternately arranged so as not to overlap each other, and the first connection lines 720a1 and the second connection lines 720b1 may cross each other.

According to another embodiment, an insulating layer may be interposed between the first connection lines 720a1 and the second connection lines 720b1 to provide stability and to prevent or substantially prevent contact between the first and second connection lines 720a1 and 720b1.

According to another embodiment, the first sensing cells 720a and the second sensing cells 720b may be integrally formed with the first connection lines 720a1 and the second connection lines 720b1, respectively, by using a transparent conductive material, such as ITO, or may be separately formed from and electrically connected to the first connection lines 720a1 and the second connection lines 720b1, respectively.

For example, the second sensing cells 720b may be integrally patterned with the second connection lines 720b1 in the column direction, and the first sensing cells 720a may be patterned such that each of the first sensing cells 720a has a separate pattern and are located between the second sensing cells 720b, while the first sensing cells 720a are connected to one another in the row direction by the first connection lines 720a1 located above or below the first sensing cells 720a.

Here, the first connection lines 720a1 may be electrically connected with the first sensing cells 720a by directly contacting the first sensing cells 720a above or below the first sensing cells 720a, or may be electrically connected with the first sensing cells 720a by a contact opening (e.g., a contact hole), etc.

The first connection lines 720a1 may include a transparent conductive material, such as ITO, or may include a non-transparent low-resistive metal material. A width of the first connection lines 720a1 may be adjusted to prevent or substantially prevent seeing the patterns.

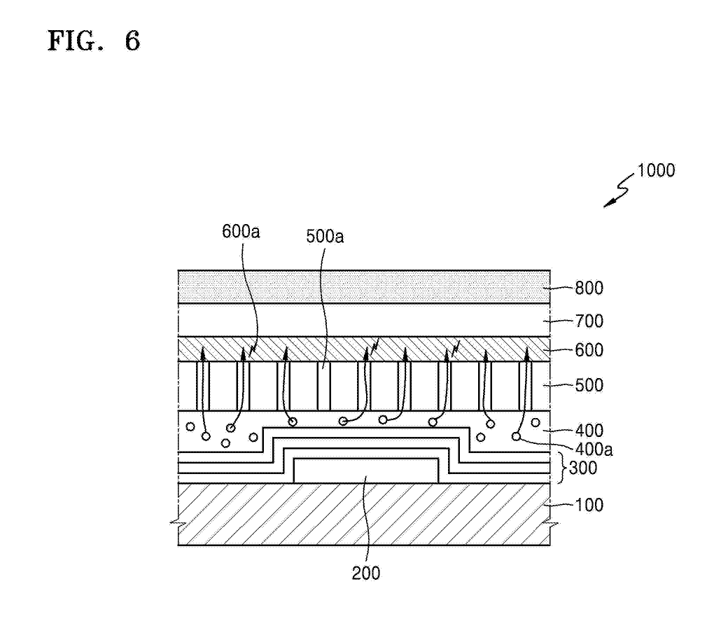

FIG. 6 is a cross-sectional view of a display apparatus 1000 according to an exemplary embodiment of the present invention, which focuses on the first layer 400, the porous layer 500, and the second layer 600.

The first layer 400 and the second layer 600 may be arranged on the substrate 100, the display unit 200, and the encapsulating unit 300, and the porous layer 500 may be arranged between the first layer 400 and the second layer 600.

The touch film 700 and the polarizing plate 800 may be sequentially stacked on the second layer 600 in this stated order.

The first layer 400 may have a thickness (e.g., a predetermined thickness) to prevent or substantially prevent parasitic capacitance from being generated between an electrode included in the display unit 200, and the touch film 700.

According to some embodiments, the first layer 400 may be an organic layer.

As illustrated in FIG. 6, the first layer 400 may include bubbles 400a.

The bubbles 400a denote outgas generated in the first layer 400 during the manufacturing process. This outgas is generally released to the outside of the first layer 400. Hereinafter, the bubbles 400a refer to this outgas, in all embodiments.

When the first layer 400 is an organic layer, at least one bubble 400a may be included in the first layer 400 in the manufacturing process. According to another embodiment, a plurality of bubbles 400a may be included in the first layer 400.

When the first layer 400 includes an organic layer to maintain a distance between the electrode and the touch film 700, adhesion between the first layer 400 and the touch film 700 may decrease, and thus, the second layer 600 for bonding the first layer 400 and the touch film 700 to each other may be included in order increase the adhesion.

According to some embodiments, the second layer 600 may be an inorganic layer.

When the second layer 600 is an inorganic layers as illustrated in FIG. 6, cracks 600a may be generated in the second layer 600 during the manufacturing process. That is, the second layer 600, which is an inorganic layer, may include at least one crack 600a in the manufacturing process.

Inorganic layers may be excellent in preventing or substantially preventing water penetration and improving adhesion, but may also be vulnerable to stress.

That is, when there is stress, cracks may more easily occur in an inorganic layer than in an organic layer that is flexible.

Thus, in the process of manufacturing the display apparatus 1000, the inorganic second layer 600 may develop cracks 600a as a result of stress becoming concentrated at it due to its relative inflexibility when compared to the encapsulating unit 300 and the organic first layer 400.

According to some embodiments, the second layer 600 may include cracks 600a as illustrated in FIG. 6.

Accordingly, when the second layer 600 is formed directly on the first layer 400, the bubbles 400a included in the first layer 400 may concentrate in the cracks 600a in the second layer 600.

The cracks 600a become a path through which the bubbles 400a may move, and thus, when the bubbles 400a move upwardly, the bubbles 400a may become concentrated in an area in which the cracks 600a are formed and may move via the cracks 600a.

That is, the bubbles 400a are transferred upwardly, while concentrating in the cracks 600a, and the concentrated bubbles 400a may be transferred to the polarizing plate 800 via the touch film 700 on the second layer 600.

In this case, when the concentrated bubbles 400a reach the polarizing plate 800, color fading of the polarizing plate 800 may occur. As a result, any partial color fading that occurs in the polarizing plate 800 may cause the polarizing plate 800 not to sufficiently perform the function of reflecting external light, and thus, the reliability of the display apparatus may deteriorate.

Therefore, the display apparatus 1000 according to the present exemplary embodiment may include the porous layer 500 between the first layer 400 and the second layer 600.

According to some embodiments, the porous layer 500 may include at least one opening 500a (e.g., at least one hole 500a).

The hole (or holes) 500a is a path which penetrates the porous layer 500, and may provide a path through which the bubbles 400a may move. That is, the bubbles 400a included in the first layer 400 may reach the second layer 600 via the holes 500a of the porous layer 500.

Accordingly, compared to the case where the first layer 400 and the second layer 600 are sequentially formed, in the case where the display apparatus includes the porous layer 500 including at least one hole 500a, the bubbles 400a may take a longer time to reach the second layer 600, and the bubbles 400a may reach the second layer 600 in a more distributed state.

According to some embodiments, the porous layer 500 may include a plurality of holes 500a, as illustrated in FIG. 6. The number of holes 500a is not limited thereto. The porous layer 500 may include at least one hole 500a.

In the porous layer 500, the plurality of holes 500a penetrating the porous layer 500 may be in a distributed state. Here, a plurality of bubbles 400a included in the first layer 400 may move through the porous layer 500 to reach the second layer 600, via the distributed and adjacent holes 500a.

The bubbles 400a that have reached the second layer 600 are transferred upwardly via the cracks 600a in the second layer 600. However, the bubbles 400a take time to move to the crack 600a, and thus, there is little or no concern that the bubbles 400a will become concentrated in the cracks 600a due to arriving at the cracks 600a all at once. As a result, the bubbles 400a may take a longer time to be transferred upwardly.

According to some embodiments, the porous layer 500 may include lithium fluoride (LiF). According to some embodiments, the porous layer 500 including LiF may be a crystal layer.

In other embodiments, the display apparatus 2000 illustrated in FIG. 2B may not include the second layer 600, and may include the porous layer 500 and the touch film 700, which are sequentially stacked on the first layer 400 in this stated order.

According to some embodiments, the porous layer 500 included in the display apparatus 2000 may be an inorganic layer. Here, when the porous layer 500 is an inorganic layer, the porous layer 500 may include at least one crack.

The crack may be included in the porous layer 500, when the porous layer 500 includes an inorganic layer, and may cause stress to become concentrated in that area.

According to some embodiments, the porous layer 500 of the display apparatus 2000 may include a plurality of openings (e.g., a plurality of holes 500a), and the holes 500a may provide a path through which the bubbles 400a of the first layer 400 may move.

Accordingly, in the display apparatus 2000, the bubbles 400a may reach the touch film 700 in a state in which the bubble 400a is distributed in the crack and the plurality of holes 500a, and thus, color fading of the touch film 700 may be prevented.

Hereinafter, a method of manufacturing a display apparatus will be described in detail by referring to FIGS. 2A and 3, according to an exemplary embodiment of the present invention.

First, the display unit 200 is formed on the substrate 100. Referring to FIG. 3, a process of forming the display unit 200 will be described in detail.

The substrate 100 may include a material having high flexibility. First, the TFT is formed on the substrate 100.

The active layers A of the TFTs may be formed, and the gate insulating layer 210 may be formed on the active layer A.

The active layers A may include a semiconductor including amorphous silicon or crystalline silicon, and may be deposited by using various deposition methods. Here, the crystalline silicon may be formed by crystallizing amorphous silicon. Methods of crystallizing amorphous silicon may include rapid thermal annealing (RTA), solid phase crystallization (SPC), excimer laser annealing (ELA), metal induced crystallization (MIC), metal induced lateral crystallization (MILC), sequential lateral solidification (SLS), etc. The active layers A may be patterned by a photolithography process.

The gate insulating layer 210 insulates the semiconductor active layers A from gate electrodes G which are to be formed on the active layers A. The gate insulating layer 210 is formed over the entire substrate 100 to cover the active layers A. The gate insulating layer 210 may include an organic or inorganic insulator. In some embodiments, the gate insulating layer 210 may include, for example, SiNₓ, SiO₂, HfO₂, or AlO₂. The gate insulating layer 210 may be formed by various deposition methods, such as sputtering, CVD, plasma enhanced chemical vapor deposition (PECVD), etc.

Next, the gate electrode G is formed on the gate insulating layer 210 to partially overlap the active layer A. Also, together with the gate electrode G, various wires may be formed.

Next, the interlayer insulating layer 230 is formed throughout the substrate and covers the gate electrode G and the wires.

The interlayer insulating layer 230 may be formed by spin coating, printing, sputtering, CVD, ALD, PECVD, HDP-CVD, vacuum deposition, etc., according to the materials of the interlayer insulating layer 230.

The source electrode S and the drain electrode D may be formed on the interlayer insulating layer 230. Next, the via layer 250 including the via hole may be formed, and the OLED may be formed on the via layer 250.

In the OLED, first, the first electrode 281 may be connected to the drain electrode D via the via hole. The intermediate layer 283 and the second electrode 285 may be sequentially formed on the first electrode 281.

Next, the encapsulating unit 300 encapsulating the display unit 200 may be formed.

The encapsulating unit 300 may be formed by alternately stacking an organic layer and an inorganic layer. According to some embodiments, the inorganic layer may be formed by CVD.

The first layer 400, the porous layer 500, and the second layer 600 may be sequentially stacked on the encapsulating unit 300 in this stated order.

The first layer 400 may be an organic layer and may be formed to have a thickness (e.g., a predetermined thickness). According to some embodiments, the first layer 400 may be formed to have a thickness of 10 μm.

The first layer 400 may include at least one bubble 400a. The bubble (or bubbles) 400a may move upwardly and may be released from the first layer 400 during the manufacturing process.

Next, the porous layer 500 may be deposited. The porous layer 500 may be formed by spin coating, printing, sputtering, CVD, ALD, PECVD, HDP-CVD, vacuum deposition, etc., according to the materials of the porous layer 500.

According to some embodiments, the porous layer 500 may include LiF.

The porous layer 500 may be deposited by vacuum deposition. According to other embodiments, the porous layer 500 may be deposited by thermal evaporation.

When the porous layer 500 is deposited by performing thermal evaporation on the LiF material, the LiF layer may have a characteristic of a crystal layer.

The porous layer 500 may include at least one hole 500a. The hole (or holes) 500a may be formed to penetrate the porous layer 500.

Accordingly, the bubbles 400a included in the first layer 400 may be released from the first layer 400 via the holes 500a and may move upwardly.

Next, according to another embodiment, the second layer 600 may be deposited on the porous layer 500.

The second layer 600 may be an inorganic layer, and may be formed to have a smaller thickness than the first layer 400.

The second layer 600 may be formed by spin coating, printing, sputtering, CVD, ALD, PECVD, HDP-CVD, vacuum deposition, etc., according to the materials of the second layer 600.

The second layer 600 may include at least one crack 600a. When the second layer 600 is an inorganic layer, the second layer 600 is vulnerable to stress, and thus, when stress is concentrated in the second layer 600a during the manufacturing process, the crack (or cracks) 600a may occur.

The bubbles 400a included in the first layer 500 may reach the cracks 600a via the holes 500a, and may move upwardly via the cracks 600a.

Next, the touch film 700, the polarizing plate 800, and the window 900 may be sequentially stacked on the second layer 600 in this stated order.

The touch film 700 may be formed to include the plurality of sensing patterns 720 (refer to FIG. 4), and the polarizing plate 800 may be formed by bonding a polarizer and a protective film, and may be stacked on the touch film 700.

The window 900 may be bonded on the polarizing plate 800 by a resin layer.

As described above, according to the one or more of the above exemplary embodiments, since an additional organic layer is provided between a light-emitting device and a touch film, parasitic capacitance may be reduced. Also, since an inorganic layer is included between the additionally provided organic layer and the touch film, adhesion may be improved. Also, since a porous layer is included between the organic layer and the inorganic layer, outgas released from the organic layer may move upwardly by penetrating the porous layer, and thus, color fading of a polarizing plate on the touch film may be prevented or substantially prevented.

It should be understood that exemplary embodiments described herein should be considered in a descriptive sense only and not for purposes of limitation. Descriptions of features or aspects within each exemplary embodiment should typically be considered as available for other similar features or aspects in other exemplary embodiments.

While one or more exemplary embodiments have been described with reference to the figures, it will be understood by those of ordinary skill in the art that various changes in form and details may be made therein without departing from the spirit and scope as defined by the following claims and their respective equivalents.

What is claimed is:

1. A display apparatus comprising:
a substrate;
a display unit on the substrate;
an encapsulating unit on the display unit, the encapsulating unit encapsulating the display unit;
a first layer on the encapsulating unit;
a porous layer on the first layer;
a touch film on the first layer; and
a polarizing plate on the touch film.

2. The display apparatus of claim 1, wherein the first layer and the porous layer comprise an organic layer and an inorganic layer, respectively.

3. The display apparatus of claim 2, wherein the first layer comprises at least one bubble.

4. The display apparatus of claim 2, wherein the porous layer comprises at least one crack.

5. The display apparatus of claim 4, wherein the porous layer has at least one hole, and the at least one hole penetrates through the porous layer.

6. The display apparatus of claim 5, wherein the porous layer has at least two holes, and the at least two holes are distributed throughout the porous layer.

7. The display apparatus of claim 1, wherein the porous layer comprises lithium fluoride.

8. A display apparatus comprising:
a substrate;
a display unit on the substrate;
an encapsulating unit on the display unit, the encapsulating unit encapsulating the display unit;
a first layer on the encapsulating unit;
a porous layer on the first layer;
a second layer on the porous layer;
a touch film on the second layer; and
a polarizing plate on the touch film.

9. The display apparatus of claim 8, wherein the first layer and the second layer comprise an organic layer and an inorganic layer, respectively.

10. The display apparatus of claim 9, wherein the first layer comprises at least one bubble.

11. The display apparatus of claim 9, wherein the second layer comprises at least one crack.

12. The display apparatus of claim 10, wherein the porous layer has at least one hole, and the at least one hole penetrates through the porous layer.

13. The display apparatus of claim 8, wherein the porous layer comprises lithium fluoride.

14. A method of manufacturing a display apparatus, the method comprising:
forming a display unit on a substrate;
forming an encapsulating unit on the display unit, the encapsulating unit encapsulating the display unit;
depositing an organic layer on the encapsulating unit;
depositing a porous layer on a first layer;
forming a touch film on the porous layer; and
forming a polarizing plate on the touch film.

15. The method of claim 14, wherein the depositing of the porous layer is performed by a thermal evaporation process.

16. The method of claim 15, wherein the porous layer deposited by the thermal evaporation process comprises a porous crystal layer comprising lithium fluoride.

17. The method of claim 14, further comprising depositing an inorganic layer on the porous layer, after depositing the porous layer.
